(19) United States
(12) Patent Application Publication
(10) Pub. No.: US 2026/0133087 A1
(43) Pub. Date: May 14, 2026

(54) CAPACITIVE PRESSURE SENSORS HAVING COBALT-ALLOY DIAPHRAGMS

(71) Applicant: Illinois Tool Works Inc., Glenview, IL (US)

(72) Inventors: Hai Mei, Pelham, NH (US); Ian Engelberg, Downingtown, PA (US)

(21) Appl. No.: 19/302,841

(22) Filed: Aug. 18, 2025

Related U.S. Application Data
(60) Provisional application No. 63/696,561, filed on Sep. 19, 2024.

(51) Int. Cl. G01L 9/00

(52) U.S. Cl. CPC G01L 9/0044; G01L 9/0072

(57) ABSTRACT

Disclosed example pressure sensors include: a first body defining a reference pressure cavity; a second body defining a measured pressure cavity and having an inlet configured to receive a fluid; a diaphragm between the reference pressure cavity and the measured pressure cavity, the diaphragm comprising Havar® alloy and having a thickness of 0.010 inches or less; an electrode separated from the diaphragm by a gap to form a capacitance between the electrode and the diaphragm; and measurement circuitry configured to determine a pressure in the measured pressure cavity based on the capacitance.

### RELATED APPLICATIONS

The present application claims the benefit of U.S. Provisional Patent Application Ser. No. 63/696,561, filed Sep. 19, 2024, entitled “CAPACITIVE PRESSURE SENSORS HAVING COBALT-ALLOY DIAPHRAGMS.” The entirety of U.S. Provisional Patent Application Ser. No. 63/696,561 is expressly incorporated herein by reference.

### FIELD OF THE DISCLOSURE

This disclosure is directed generally to pressure sensors and, more particularly, to capacitive pressure sensors having cobalt-alloy diaphragms.

### BACKGROUND

Pressure sensors, or pressure transducers, measure the pressure of a fluid input to the sensor compared to a reference pressure. Pressure sensors may be constructed to compare the input pressure to a fixed reference pressure or to a variable reference pressure.

### SUMMARY

Capacitive pressure sensors having cobalt-alloy diaphragms are disclosed, substantially as illustrated by and described in connection with at least one of the figures, as set forth more completely in the claims.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1A is a block diagram of an example process control system including a pressure transducer having a fixed reference pressure, in accordance with aspects of this disclosure.

FIG. 1B is a block diagram of an example process control system including a pressure transducer coupled to a variable source of reference pressure, in accordance with aspects of this disclosure.

FIG. 2 is a schematic diagram of an example pressure sensor which may be used to implement the pressure sensors of FIGS. 1A and/or 1B, in accordance with aspects of this disclosure.

The figures are not necessarily to scale. Wherever appropriate, similar or identical reference numerals are used to refer to similar or identical components.

### DETAILED DESCRIPTION

For the purpose of promoting an understanding of the principles of the claimed technology and presenting its currently understood, best mode of operation, reference will be now made to the embodiments illustrated in the drawings and specific language will be used to describe the same. It will nevertheless be understood that no limitation of the scope of the claimed technology is thereby intended, with such alterations and further modifications in the illustrated device and such further applications of the principles of the claimed technology as illustrated therein being contemplated as would typically occur to one skilled in the art to which the claimed technology relates.

The sensitivity of a CDG sensor primarily depends on several factors: diaphragm diameter, diaphragm thickness, diaphragm tension, and the spacing between the diaphragm and the electrode. A larger diaphragm diameter increases sensitivity to pressure but also makes the gauge more sensitive to gravitational effects, leading to greater output differences between vertical and horizontal orientations. Additionally, the diameter of the diaphragm impacts the overall CDG size. The sensitivity of the diaphragm to pressure is inversely related to its thickness; the thinner the diaphragm, the more sensitive the diaphragm. However, the thickness is constrained by the material properties and the manufacturing process capabilities (e.g., cold-rolling), as well as the need to maintain the integrity of the diaphragm against leaks. Tension in the diaphragm is set to maintain linearity and provide repeatability of the diaphragm displacement in response to pressure changes. Lower tension increases sensitivity, but the value and uniformity of the tension may be limited by the manufacturing process. The capacitance value is inversely proportional to the spacing between the diaphragm and the electrode, with sensitivity being inversely proportional to the square of the gap. The gap size is limited by factors such as parallelism, machining tolerances, and capacitance matching in dual-capacitance designs. Capacitance diaphragm gauges (CDGs) are employed in quantum computing, semiconductor, and/or industrial applications. Conventional CDGs include a diaphragm constructed using nickel alloys, such as Inconel® alloy, for the diaphragm material.

Disclosed example pressure sensors, such as CDGs, use diaphragms constructed using a cobalt-based alloy, such as the Havar® alloy. Due to the improve strength of the Havar® alloy compared with Inconel® alloy and other conventional alloys, disclosed pressure sensors have improved sensitivity, leak resistance, linearity, and repeatability, allowing use and improved performance at low input pressures. Disclosed examples may also permit a smaller overall sensor size due to the ability to reduce the diameter of the diaphragm.

As used herein, the term “fluid” includes matter in both liquid and gaseous states.

Disclosed example pressure sensors include: a first body defining a reference pressure cavity; a second body defining a measured pressure cavity and having an inlet configured to receive a fluid; a diaphragm between the reference pressure cavity and the measured pressure cavity, the diaphragm including Havar® alloy and having a thickness of 0.003 inches or less; an electrode separated from the diaphragm by a gap to form a capacitance between the electrode and the diaphragm; and measurement circuitry configured to determine a pressure in the measured pressure cavity based on the capacitance.

In some example pressure sensors, the diaphragm has a thickness of 0.0025 inches or less, and the diaphragm is pretensioned between the first and second body. In some example pressure sensors, the diaphragm has a thickness of 0.001 inches or less. In some example pressure sensors, the diaphragm is pretensioned between the first and second body. In some example pressure sensors, the diaphragm has a thickness of 0.0005 inches or less. In some example pressure sensors, the diaphragm is pretensioned between the first and second body.

In some example pressure sensors, the diaphragm has a thickness of 0.0004 inches or less. In some example pressure sensors, the diaphragm is pretensioned between the first and second body. In some example pressure sensors, the diaphragm has a thickness of 0.0003 inches or less. In some example pressure sensors, the diaphragm is pretensioned between the first and second body.

In some example pressure sensors, the diaphragm is configured to have a full scale upper pressure limit of 500 torr or less. In some example pressure sensors, the diaphragm is configured to have a full scale upper pressure limit of 100 torr or less. In some example pressure sensors, the diaphragm is configured to have a full scale upper pressure limit of 10 torr or less. In some example pressure sensors, the diaphragm is configured to have a full scale upper pressure limit of 1 torr or less. In some example pressure sensors, the diaphragm is configured to have a full scale upper pressure limit of 100 millitorr or less.

In some example pressure sensors, the diaphragm is configured to have a full scale upper pressure limit of 1500 torr or less. In some such examples, the diaphragm pretensioned between the first and second body. In some example pressure sensors, the diaphragm has a thickness of 0.006 inches or less. In some such example pressure sensors, the diaphragm is configured to have a full scale upper pressure limit of 1000 torr or less.

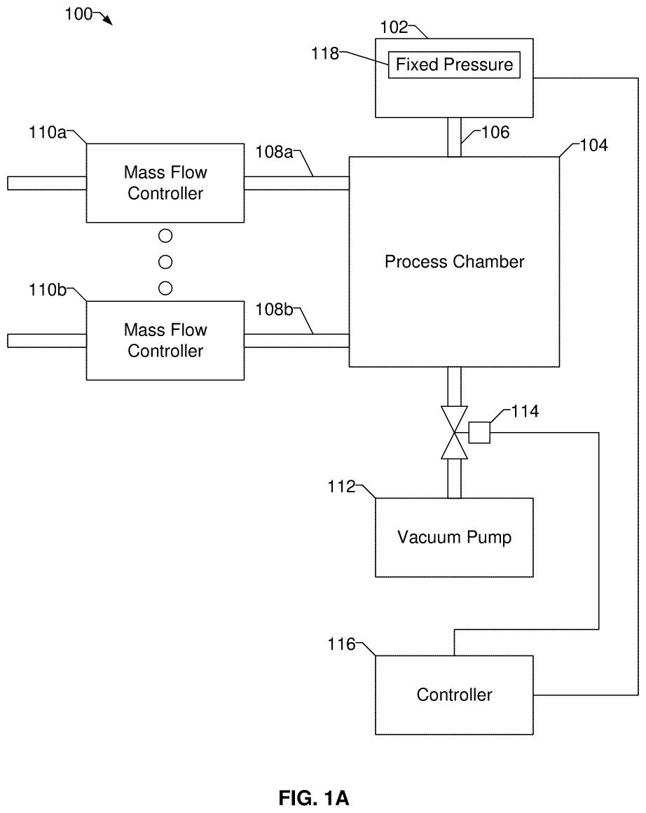

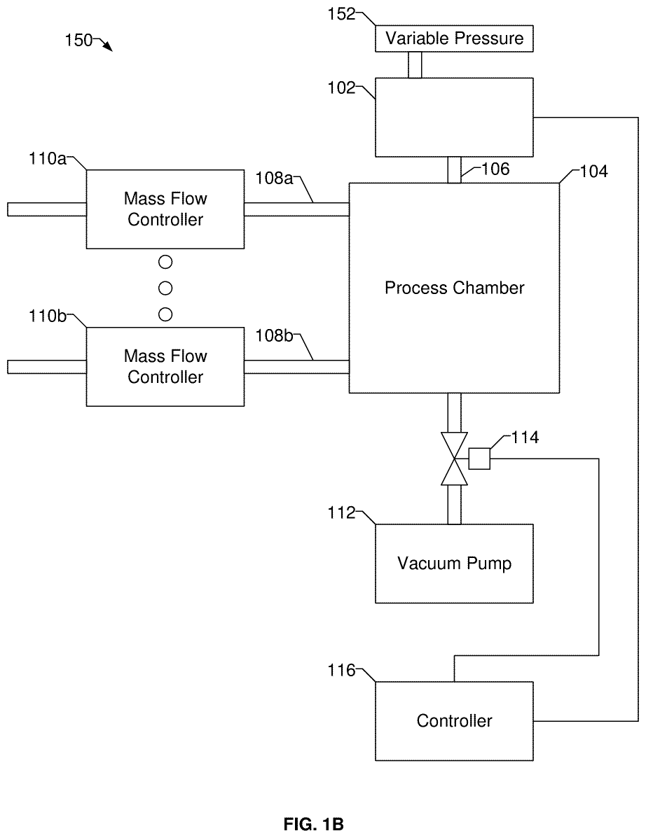

FIG. 1A is a block diagram of an example process control system 100 including a pressure sensor 102. The example process control system 100 of FIG. 1 includes a process chamber 104, to which the pressure sensor 102 is fluidly coupled via a fluid input line 106 to measure the pressure of the process chamber 104.

The example process chamber 104 may receive one or more inputs, such as process feed materials, via a corresponding number of feed lines 108a, 108b, which may be controlled via mass flow controllers 110a, 110b.

The example system 100 may include a vacuum pump 112, or other pressure control pump, and a valve 114 to control a flow rate between the vacuum pump 112 and the process chamber 104. The valve 114 may be controlled by a controller 116, computing device, and/or any other control technique, to maintain the pressure in the process chamber 104 within a desired range. The example pressure sensor 102 is communicatively coupled to the controller 116 to provide pressure feedback to the controller 116 (e.g., for use in a pressure control loop). For example, as the pressure in the process chamber 104 increases, the pressure sensor 102 measures the pressure and provides a signal representative of the pressure to the controller 116, which then controls the valve 114 to increase the flow rate from the process chamber 104 to the vacuum pump 112. The vacuum pump 112 may have an output to any appropriate location based on the nature of the process.

In the example of FIG. 1A, the pressure sensor 102 is configured with a fixed pressure 118, to which an input pressure of a fluid received via the fluid input line 106 is compared to output a pressure signal. For example, as discussed in more detail below, the pressure sensor 102 may be provided with a sealable evacuation port which may be sealed when the desired pressure is provided within the pressure sensor 102, and/or the pressure sensor 102 may be assembled and sealed within a volume having the desired reference pressure. The fixed pressure 118 may be a vacuum pressure or another predetermined fixed reference pressure which may be below, at, or above a nominal atmospheric pressure. In the configuration of FIG. 1A, the pressure sensor 102 may be used as an absolute pressure sensor.

FIG. 1B is a block diagram of another example process control system 150. The example process control system 150 includes the example pressure sensor 102, the process chamber 104, the fluid input line 106, the feed lines 108a, 108b, the mass flow controllers 110a, 110b, the vacuum pump 112, the valve 114, and the controller 116 of FIG. 1A. In the example of FIG. 1B, the pressure sensor 102 is coupled to a variable source 152 of reference pressure that is external to the pressure sensor 102. For example, the pressure sensor 102 may have a port (e.g., a selectively scalable evacuation port) that is connected to a source of reference pressure to operate as a pressure sensor with a variable reference, and/or which is vented to an ambient pressure to operate as a pressure gauge.

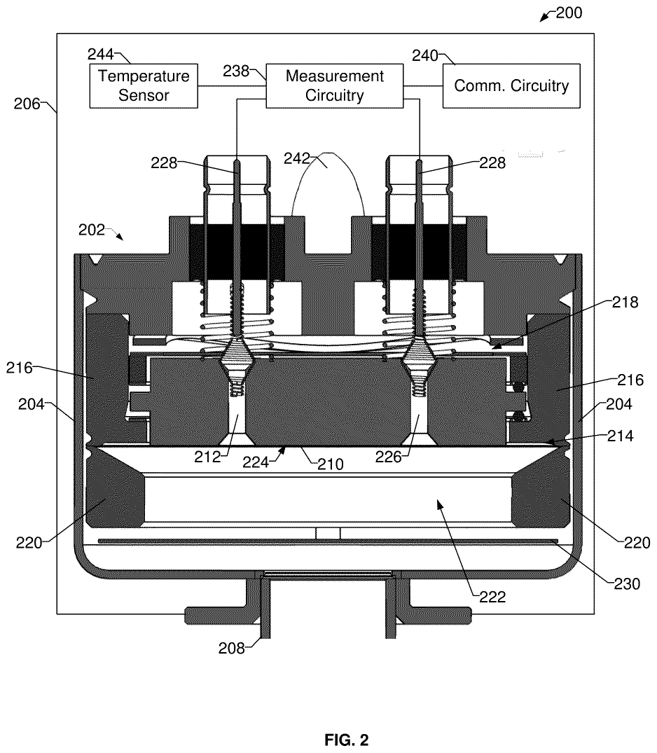

FIG. 2 is a schematic diagram of an example pressure sensor 200 which may be used to implement the pressure sensors 102 of FIGS. 1A and/or 1B. The example pressure sensor 200 includes a pressure measurement assembly 202, an inner housing 204, and an outer housing 206. The pressure sensor 200 receives a fluid via a fluid input line 208 (e.g., the fluid input line 106 of FIG. 1), measures the absolute pressure of the received fluid, and outputs one or more signals representative of the measured pressure.

The pressure measurement assembly 202 is a capacitive diaphragm gauge (CDG) sensor attached to the fluid input line 208. The pressure measurement assembly 202 may also be referred to as the “sensor core,” in that the pressure measurement assembly 202 performs the measurements which are converted to output signals. The pressure measurement assembly 202 is at least partially surrounded by the inner housing 204. The inner housing 204 may provide thermal insulation and/or physical protection to the pressure measurement assembly 202. Both the pressure measurement assembly 202 and the inner housing 204 are at least partially surrounded by the outer housing 206. The outer housing 206 may provide thermal insulation and/or physical protection to the pressure measurement assembly 202.

In the illustrated example, the pressure measurement assembly 202 is a capacitance pressure sensor, in which a flexible diaphragm 210 is separated from an electrode 212 by a gap 214. The pressure measurement assembly 202 includes a first body 216 that defines a reference pressure cavity 218, and a second body 220 that defines a measured pressure cavity 222. The second body 220 is coupled to the fluid input line 208, such that the measured pressure cavity 222 has the same pressure as the fluid in the fluid input line 208. For example, the second body 220 may be welded, brazed, or otherwise sealed against the fluid input line 208 to provide a hermetic seal.

Some conventional capacitance diaphragm gauge-based sensors use Inconel® alloy to construct the diaphragm. In the example pressure sensor 200, the diaphragm 210 is constructed using a non-magnetic, cobalt-based alloy such as Havar® alloy, which is sold by Hamilton Precision Metals and corresponds to unified numbering system (UNS) R30004. Compared with Inconel® alloy, Havar® alloy provides a combination of improved corrosion resistance, approval for use with halogens and halides, increased tensile strength, increased yield strength, and improved leak resistance at thinner thicknesses.

Havar® alloy has the following nominal composition, which may vary within accepted standards of manufacturing. Additionally or alternatively, the composition may be modified while maintaining (e.g., within +/−5% of the nominal composition) the corrosion resistance, the tensile strength, and/or the yield strength of the nominal composition.

### Composition % by Mass:

| | |
|---|---|
| Cobalt | 42.0% |
| Chromium | 19.5% |
| Nickel | 12.7% |
| Tungsten | 2.7% |
| Molybdenum | 2.2% |
| Manganese | 1.6% |
| Carbon | 0.2% |
| Iron | Balance |

The improved mechanical strength and elasticity limits of Havar-based diaphragms allow the diaphragm 210 to be constructed to be thinner than in conventional CDGs, allowing thinner diaphragm thickness and higher sensitivity, while withstanding the same overpressure conditions as higher-pressure vacuum manometers.

In some examples, the Havar® alloy-based diaphragm 210 has a thickness of 0.003 inches or less. In some examples, the Havar® alloy-based diaphragm 210 has a thickness of 0.0025 inches or less and, in some such examples, the diaphragm 210 is pretensioned between the first body 216 and the second body 220.

In some examples, the Havar® alloy-based diaphragm 210 has a thickness of 0.001 inches or less and, in some such examples, the diaphragm 210 is pretensioned between the first body 216 and the second body 220.

In some examples, the Havar® alloy-based diaphragm 210 has a thickness of 0.0005 inches or less and, in some such examples, the diaphragm 210 is pretensioned between the first body 216 and the second body 220.

In some examples, the Havar® alloy-based diaphragm 210 has a thickness of 0.0004 inches or less and, in some such examples, the diaphragm 210 is pretensioned between the first body 216 and the second body 220.

In some examples, the Havar® alloy-based diaphragm 210 has a thickness of 0.0003 inches or less and, in some such examples, the diaphragm 210 is pretensioned between the first body 216 and the second body 220.

In some examples, the Havar® alloy-based diaphragm 210 has a thickness of 0.010 inches or less. In some such examples, the diaphragm 210 is pretensioned between the first body 216 and the second body 220, and may have a full scale upper pressure limit of 1500 torr or less.

In some examples, the Havar® alloy-based diaphragm 210 has a thickness of 0.006 inches or less. In some such examples, the diaphragm 210 is pretensioned between the first body 216 and the second body 220, and may have a full scale upper pressure limit of 1000 torr or less.

As the pressure at the fluid input line 208 changes relative to a reference pressure in the reference pressure cavity 218 (e.g., a vacuum pressure), the diaphragm 210 moves or flexes, changing the capacitance at the measurement electrode 212 in an amount that corresponds to the pressure at the fluid input line 208 and/or in the measured pressure cavity 222.

In disclosed examples, the pressure measurement assembly 202 including the Havar® alloy-based diaphragm 210 provides a higher precision and stability for measurements in low pressure applications, particularly when compared with conventional CDG pressure sensors using Inconel® alloy-based diaphragms. In some such examples, the reference pressure cavity 218 may be established to have a vacuum pressure.

In some examples, the pressure measurement assembly 202 including the Havar® alloy-based diaphragm 210 is configured to have a full scale upper pressure limit (e.g., the pressure in the measured pressure cavity 222) of 500 torr or less. In some examples, the pressure measurement assembly 202 including the Havar® alloy-based diaphragm 210 is configured to have a full scale upper pressure limit of 100 torr or less. In some examples, the pressure measurement assembly 202 including the Havar® alloy-based diaphragm 210 is configured to have a full scale upper pressure limit of 10 torr or less. In some examples, the pressure measurement assembly 202 including the Havar® alloy-based diaphragm 210 is configured to have a full scale upper pressure limit of 1 torr or less. In some examples, the pressure measurement assembly 202 including the Havar® alloy-based diaphragm 210 is configured to have a full scale upper pressure limit of 10 millitorr or less. The thickness of the diaphragm 210 may be selected to provide a desired sensitivity based on the configured full scale pressure.

In the example of FIG. 2, the pressure measurement assembly 202 further includes a reference electrode 226, which also measures the capacitance as the diaphragm 210 moves in response to the pressure. The electrodes 212, 226 are metalized to form two capacitances with the flexible diaphragm 210. The signals generated by both electrodes 212, 226 change with the pressure but change at different rates. The signals from the reference electrode 226 are output via signal ports 228, and may be used to measure and offset common mode error (e.g., temperature induced error).

The capacitance signal is output from the pressure measurement assembly 202 via the signal ports 228, which is coupled to measurement circuitry 238 that converts the capacitance to a measurement signal and/or outputs the capacitance signal to an external signal conversion device. The measurement circuitry 238 may correct the measurement signal(s). The measurement signal(s), representative of the measured pressure in the pressure measurement assembly 202, may then be transmitted by the measurement circuitry 238 (e.g., to the controller 116 of FIG. 1A or 1B, to another control and/or data collection device, etc.) via communications circuitry 240 (e.g., a connector). In the example of FIG. 2, the example measurement circuitry 238 and the communications circuitry 240 are mounted within the pressure sensor 200 on one or more circuit boards.

To perform measurements and processing, the measurement circuitry 238 may be implemented using at least one controller or processor that controls the operations of the pressure sensor 200. The measurement circuitry 238 receives and processes multiple inputs. The measurement circuitry 238 may include one or more microprocessors, such as one or more “general-purpose” microprocessors, one or more special-purpose microprocessors and/or ASICS, and/or any other type of processing device. For example, the measurement circuitry 238 may include one or more digital signal processors (DSPs). The measurement circuitry 238 may further include memory devices and/or data storage devices.

The pressure sensor 200 may include a plasma shield 230 or other guard positioned between the fluid input line 208 diaphragm 210. The plasma shield 230 includes one or more apertures to allow the pressure of the input fluid to be applied to the diaphragm 210, but includes one or more surfaces to block contaminants, thereby reducing accumulation of contaminants on the diaphragm 210.

Example materials that may be used to construct the first body 216 and/or the second body 220 include corrosion resistant alloys, such as nickel alloys (e.g., Inconel® alloy) and/or superalloys, cobalt superalloys, iron superalloys, aluminum, copper alloys, titanium, and/or stainless steel.

To set a fixed reference pressure, the first body 216 may include an evacuation port 242 (e.g., a pinch tube or pinch-off tube). The evacuation port 242 is in fluid communication with the reference pressure cavity 218. During manufacturing and after sealing of the pressure measurement assembly 202, the pressure (e.g., vacuum or other set pressure) within the reference pressure cavity 218 is drawn via the evacuation port 242, which is pinched to seal the reference pressure cavity 218 when the desired pressure level is reached. In some other examples, the pressure measurement assembly 202 may be constructed and sealed in a volume in which the desired reference pressure is present, which fixes the desired reference pressure within the reference pressure cavity 218 when the evacuation port 242 is sealed via welding or pinch-off cold welding in a fixed pressure chamber.

In some examples in which a fixed reference pressure is set, a getter may be installed within the reference pressure cavity 218 and activated during manufacture, such as when the fixed reference pressure is established but before the reference pressure cavity 218 is sealed. Additionally or alternatively, the inner surfaces of the reference pressure cavity 218 (e.g., the first body 216 adjacent the reference pressure cavity 218, the electrode 212) are coated with a substance that reduces or prevents outgassing. An example coating that may be used is Parylene-C.

In some other examples, the evacuation port 242 may be left open to ambient pressure and/or connected to a variable source of reference pressure.

The inner housing 204 is attached to the second body 220 (e.g., using glue, welding, pressure fit, etc.). The outer housing 206 is secured to the measurement circuitry 238 and/or to the inner housing 204 (e.g., via fasteners, adhesive, welding, etc.).

The pressure sensor 200 further includes a temperature sensor 244 coupled to the measurement circuitry 238. The temperature sensor 244 measures an ambient or other environmental temperature that may affect the measurements by the electrodes 212, 226. For example, changes in temperature may change the size of the gap 214 and/or the tension of the diaphragm 210.

As utilized herein, “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations.

While the present method and/or system has been described with reference to certain implementations, it will be understood by those skilled in the art that various changes may be made, and equivalents may be substituted without departing from the scope of the present method and/or system. For example, block and/or components of disclosed examples may be combined, divided, re-arranged, and/or otherwise modified. In addition, many modifications may be made to adapt a particular situation or material to the teachings of the present disclosure without departing from its scope. Therefore, the present method and/or system are not limited to the particular implementations disclosed. Instead, the present method and/or system will include all implementations falling within the scope of the appended claims, both literally and under the doctrine of equivalents.

What is claimed is:

1. A pressure sensor, comprising:
a first body defining a reference pressure cavity;
a second body defining a measured pressure cavity and having an inlet configured to receive a fluid;
a diaphragm between the reference pressure cavity and the measured pressure cavity, the diaphragm comprising Havar® alloy and having a thickness of 0.010 inches or less;
an electrode separated from the diaphragm by a gap to form a capacitance between the electrode and the diaphragm; and
measurement circuitry configured to determine a pressure in the measured pressure cavity based on the capacitance.

2. The pressure sensor as defined in claim 1, wherein the diaphragm has a thickness of 0.0025 inches or less, and the diaphragm is pretensioned between the first and second body.

3. The pressure sensor as defined in claim 1, wherein the diaphragm has a thickness of 0.001 inches or less.

4. The pressure sensor as defined in claim 3, wherein the diaphragm is pretensioned between the first and second body.

5. The pressure sensor as defined in claim 3, wherein the diaphragm has a thickness of 0.0005 inches or less.

6. The pressure sensor as defined in claim 5, wherein the diaphragm is pretensioned between the first and second body.

7. The pressure sensor as defined in claim 5, wherein the diaphragm has a thickness of 0.0004 inches or less.

8. The pressure sensor as defined in claim 7, wherein the diaphragm is pretensioned between the first and second body.

9. The pressure sensor as defined in claim 7, wherein the diaphragm has a thickness of 0.0003 inches or less.

10. The pressure sensor as defined in claim 9, wherein the diaphragm is pretensioned between the first and second body.

11. The pressure sensor as defined in claim 1, wherein the diaphragm is configured to have a full scale upper pressure limit of 500 torr or less.

12. The pressure sensor as defined in claim 1, wherein the diaphragm is configured to have a full scale upper pressure limit of 100 torr or less.

13. The pressure sensor as defined in claim 1, wherein the diaphragm is configured to have a full scale upper pressure limit of 10 torr or less.

14. The pressure sensor as defined in claim 1, wherein the diaphragm is configured to have a full scale upper pressure limit of 1 torr or less.

15. The pressure sensor as defined in claim 1, wherein the diaphragm is configured to have a full scale upper pressure limit of 100 millitorr or less.

16. The pressure sensor as defined in claim 1, wherein the diaphragm is configured to have a full scale upper pressure limit of 1500 torr or less.

17. The pressure sensor as defined in claim 16, wherein the diaphragm is pretensioned between the first and second body.

18. The pressure sensor as defined in claim 1, wherein the diaphragm has a thickness of 0.006 inches or less.

19. The pressure sensor as defined in claim 18, wherein the diaphragm is configured to have a full scale upper pressure limit of 1000 torr or less.
